(19) United States
(12) Patent Application Publication
(10) Pub. No.: US 2020/0135034 A1
(43) Pub. Date: Apr. 30, 2020

(54) COMMUNICATION METHOD, COMMUNICATION SYSTEM AND AIRCRAFT/SPACECRAFT

(71) Applicant: Airbus Operations GmbH, Hamburg (DE)

(72) Inventors: Maurice GIROD, Hamburg (DE); Uwe BARTELS, Hamburg (DE)

(21) Appl. No.: 15/895,639

(22) Filed: Feb. 13, 2018

(30) Foreign Application Priority Data
Feb. 16, 2017 (DE) 10 2017 202 494.1

(51) Int. Cl. G08G 5/00; B64D 45/00

(52) U.S. Cl. CPC G08G 5/0004; B64D 2045/0065; B64D 45/00; G08G 5/003

(57) ABSTRACT

A communication method for satellite-based communication for an aircraft/spacecraft includes monitoring the availability of a first satellite-based communication system, and transmitting aircraft/spacecraft data via the first satellite-based communication system or a second satellite-based communication system depending on the availability of the first satellite-based communication system.

### CROSS-REFERENCE TO RELATED APPLICATION

This application claims priority to German Patent Application DE 10 2017 202 494.1, filed on Feb. 16, 2017, the entire disclosure of which is incorporated by reference herein.

### TECHNICAL FIELD

The present disclosure relates to a communication method, a communication system and an aircraft/spacecraft.

### BACKGROUND

Nowadays, aircraft/spacecraft usually have options for storing data regarding the aircraft/spacecraft during the flight. Data of this kind are used for evaluation and for root cause analysis, for example after an incident.

Flight data recorders, which store data during the flight, are usually used in aircraft/spacecraft for this purpose. After an incident, the flight data recorders are located and recovered. After it has been recovered, the stored data can be extracted and analyzed.

For the purpose of being located, the flight data recorders usually comprise a locating aid, known as an underwater locater beacon, which emits an acoustic signal having a frequency of approximately 37.5 kHz, which can be located using sonar-based techniques. The detection range for an acoustic signal of this kind is approximately 4000 m.

In order to improve the process of locating a flight data recorder of this kind, locating aids which emit an acoustic signal having a frequency of approximately 8.8 kHz can also be used in modern flight data recorders. The acoustic signals having a frequency of 8.8 kHz can be located over a distance of approximately 13 km.

A possible locating aid is disclosed for example in WO 2013 088 275 A1.

The particular locating aid and thus also the aircraft/spacecraft can be located and recovered during an incident at sea, for example by recovery ships, which attempt to detect and pinpoint the acoustic signal of the locating aid.

### SUMMARY

Against this background, it is an idea of the present disclosure to make it possible to capture flight data in a simplified manner.

A communication method for satellite-based communication for an aircraft/spacecraft is provided accordingly. The communication method comprises monitoring the availability of a first satellite-based communication system, and transmitting aircraft/spacecraft data via the first satellite-based communication system or a second satellite-based communication system depending on the availability of the first satellite-based communication system.

Furthermore, a communication system is provided. The communication system comprises a communication device which is designed or configured to communicate with a first satellite-based communication system and with a second satellite-based communication system, and a control device, which is coupled to the communication device and which is designed or configured to monitor the availability of the first satellite-based communication system. The control device is further designed or configured to transmit aircraft/spacecraft data via the first satellite-based communication system or the second satellite-based communication system depending on the availability of the first satellite-based communication system.

Finally, an aircraft/spacecraft comprising a communication system according to the disclosure herein is provided. In this context, an aircraft/spacecraft can be understood to mean any aircraft and spacecraft.

The present disclosure is based on the knowledge that aircraft/spacecraft data can be evaluated very easily if the data have already been output to a central data management system, for example, during operation of the aircraft/spacecraft.

The present disclosure uses this knowledge and provides a system in an aircraft/spacecraft which stores the aircraft/spacecraft data and can already output the data in a satellite-based manner during the operation of the aircraft/spacecraft. In this case, the aircraft/spacecraft data can be the data that a flight data recorder conventionally stores. Data of this kind can thus comprise, for example, flight data, such as the position and orientation of the aircraft/spacecraft, audio data from the cockpit or cabin of the aircraft/spacecraft, image data from the cockpit or cabin of the aircraft/spacecraft, or the like.

The present disclosure therefore supplements conventional flight data recorders, for example, in that the aircraft/spacecraft data can already be output before and/or during an incident. If all flight data have already been output during the incident, it may even be possible to dispense with the recovery of the flight data recorder.

In this case, the present disclosure further considers various properties of satellite-based communication systems. Therefore, the transmission of the aircraft/spacecraft data can be continued via the second satellite-based communication system when the availability of the first satellite-based communication system is reduced.

According to a development, the first satellite-based communication system may comprise geostationary satellites. Additionally or alternatively, the second satellite-based communication system may comprise non-geostationary satellites.

For satellite-based communication systems comprising geostationary satellites, the geostationary satellites, for reasons relating to physics, need to be vertically over the equator. The geostationary satellites remain invariably over the same point on the equator. As a result, to an observer at a fixed point on the Earth's surface, the geostationary satellites appear to be always in the same position in the sky.

In order to communicate with a satellite of a satellite-based communication system of this kind, this satellite needs to be targeted precisely. This usually happens only once when the antenna is adjusted, for example in buildings. However, if an aircraft/spacecraft uses satellite-based communication via a satellite-based communication system comprising geostationary satellites, the antenna in the aircraft/spacecraft needs to be readjusted during the flight.

Since the satellites of a satellite-based communication system comprising geostationary satellites need to be vertically above the equator in order to maintain their position relative to the Earth, communication with a satellite-based communication system of this kind is not possible at the polar ice caps. Since satellite-based communication systems comprising geostationary satellites are usually used for stationary applications, the availability is likewise limited over the ocean.

Communication via a satellite-based communication system comprising geostationary satellites further has increased energy requirements. The communication systems for communication via a satellite-based communication system comprising geostationary satellites are usually quickly disconnected in the event of a fault or a problem.

However, satellite-based communication systems comprising geostationary satellites have a high data transmission rate and can be used cost effectively to transmit aircraft/spacecraft data from the aircraft/spacecraft.

The INMARSAT system can be cited as an example of a satellite-based communication system comprising geostationary satellites.

Owing to the high bandwidth provided by the first satellite-based communication system, the aircraft/spacecraft data can also be stored and transmitted as a packet, for example. In this case, the size of the packet can be selected depending on the desired timeliness of the aircraft/spacecraft data. By selecting larger packets, the overhead costs of the data transmission process can be further reduced.

For satellite-based communication systems comprising non-geostationary satellites, the satellites orbit the Earth. In this case, the satellites move relative to the Earth. In this case, communication via such satellite-based communication systems comprising non-geostationary satellites does not take place using a single satellite which needs to be precisely targeted. Instead, communication via such satellite-based communication systems comprising non-geostationary satellites takes place using alternating satellites, which can be reached by the communication device at any given moment. The steps of guiding the antennae and targeting individual satellites, for example, are correspondingly omitted.

For a satellite-based communication system comprising non-geostationary satellites, a plurality of antennae can be grouped into the individual participants, for example, which antennae illuminate the individual “cells” or regions, or corresponding phased-array antennae having multi-lobe characteristics can be used. In this case, the regions or cells are adapted such that a sufficient number of satellites for communication can always be targeted.

In a satellite-based communication system of this kind, the satellites can form their own data transmission network. Data received by a satellite can thus be transmitted from satellite to satellite, for example, until one of the satellites transmits the data to an earth station.

Since the non-geostationary satellites are not in a fixed position relative to the Earth's surface, but rather orbit the Earth, the satellites can also fly over the polar ice caps and ocean, for example. Owing to a sufficiently dense network of satellites, a permanent or almost permanent availability can be provided over the entire globe.

Owing to the fundamentally different data transmission principles in comparison with the satellite-based communication systems comprising geostationary satellites, the satellite-based communication systems comprising non-geostationary satellites achieve lower data transmission rates. However, the antennae do not need to be directed towards the satellites. As a result, data transmission is also still possible if the current orientation or position of the aircraft/spacecraft is unknown or can no longer be detected, for example.

The IRIDIUM system can be cited as an example of a satellite-based communication system comprising non-geostationary satellites.

According to a development, aircraft/spacecraft data can be transmitted via the first satellite-based communication system when the first satellite-based communication system is fully available and transmitted via the second satellite-based communication system when the availability of the first satellite-based communication system is limited.

As already explained above, communication by a satellite-based communication system comprising geostationary satellites is only possible in a limited manner, specifically if the current position of the aircraft/spacecraft is covered by a satellite and it is possible to guide the antenna.

By contrast, communication by a satellite-based communication system comprising non-geostationary satellites is possible across almost the entire globe. Furthermore, it is not necessary to guide the antenna. The potentially lower data rate is taken into account here.

According to a development, the availability of the first satellite-based communication system can be determined on the basis of a measurement of the quality of the connection to the first satellite-based communication system.

The measurement of the connection quality can comprise, for example, a measurement of the signal-to-noise ratio, the data rate, the signal power or the like. This measurement can be, for example, an absolute or a relative measurement. If the connection quality falls below a predetermined threshold, it is possible to switch to the second satellite-based communication system for further communication.

According to a development, the availability of the first satellite-based communication system can be determined on the basis of a current position of the aircraft/spacecraft vehicle. For this purpose, an item of information or a card can be provided, for example, which describes the coverage by the first satellite-based communication system. If the aircraft/spacecraft nears an edge region, i.e. a transition from a covered region to a non-covered region of the first satellite-based communication system, communication can already be switched to the second satellite-based communication system as a precaution. For this purpose, the flight direction of the aircraft/spacecraft can also be taken into account, for example.

According to a development, the aircraft/spacecraft data can be transmitted via the second satellite-based communication system when the aircraft/spacecraft is in an abnormal condition.

Abnormal operation of the aircraft/spacecraft is understood to be any flight situation in which the aircraft/spacecraft is not in normal operation. During abnormal operation of the aircraft/spacecraft, an emergency situation, for example, can therefore arise which makes controlling the aircraft/spacecraft harder or impossible, or which limits the operation of the aircraft/spacecraft in another manner.

According to a development, when the aircraft/spacecraft is in the abnormal condition, only a selection of the aircraft/spacecraft data can be transmitted. However, this can also apply generally to data transmission via the second satellite-based communication system.

If communication is switched to the second satellite-based communication system, it is possible that the system may transmit less data than the first satellite-based communication system. The selection of flight data can consequently have a subset of the data transmitted via the first satellite-based communication system. In the event of an emergency in an aircraft/spacecraft, it is important to be able to evaluate the most up-to-date data. The selection can therefore comprise in particular a mixture of stored aircraft/spacecraft data and real-time data from the aircraft/spacecraft, for example. In this case, the real-time data correspond in nature to the stored aircraft/spacecraft data. However, the real-time data are not collected and stored but rather directly transmitted after being captured. Nevertheless, storage in a flight data recorder is of course possible.

According to a development, the communication method can comprise storing the aircraft/spacecraft data during operation of the aircraft/spacecraft and transmitting the aircraft/spacecraft data subject to timeliness of the aircraft/spacecraft data. In this case, in particular the most up-to-date aircraft/spacecraft data can be transmitted first.

For communication via the satellite-based communication systems, amounts of aircraft/spacecraft data may be too large for the available data rate. Consequently, not all aircraft/spacecraft data generated can be transmitted. In a situation of this kind, it is advantageous to transmit the most up-to-date aircraft/spacecraft data first. If the amount of aircraft/spacecraft data generated is reduced, because, for example, fewer aircraft/spacecraft data are requested by a central collection point or the available bandwidth is increased, it is also possible to additionally transmit legacy data. The available bandwidth can be increased, for example, if the weather conditions are advantageous for satellite-based communication.

The above-mentioned embodiments and developments can be combined in any manner, if appropriate. Further possible embodiments, developments and implementations of the disclosure herein include combinations of features of the disclosure herein described previously or below with respect to the embodiments, even if not explicitly specified. In particular, a person skilled in the art will also add individual aspects as improvements or supplements to the particular basic form of the present disclosure.

### BRIEF DESCRIPTION OF THE DRAWINGS

The present disclosure will be described in greater detail below with reference to the embodiments shown in the schematic, example drawings, in which:

FIG. 1 is a flow chart of an embodiment of a communication method according to the disclosure herein;

FIG. 2 is a flow chart of another embodiment of a communication method according to the disclosure herein;

FIG. 3 is a block diagram of an embodiment of a communication system according to the disclosure herein;

FIG. 4 is a block diagram of another embodiment of a communication system according to the disclosure herein; and

FIG. 5 is a block diagram of another embodiment of an aircraft/spacecraft according to the disclosure herein.

The accompanying drawings are intended to facilitate further understanding of the embodiments of the disclosure herein. The drawings illustrate embodiments and, together with the description, serve to explain principles and concepts of the disclosure herein. Other embodiments and many of the advantages mentioned can be found with reference to the drawings. The elements of the drawings are not necessarily shown true to scale relative to one another.

In the figures of the drawings, the same elements, features and components are provided with the same reference signs in each case, unless otherwise specified.

### DETAILED DESCRIPTION

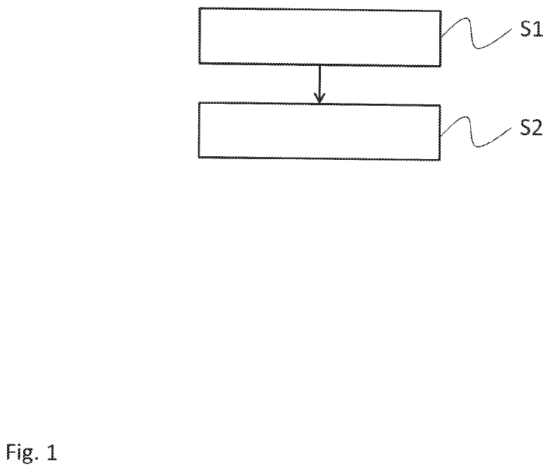

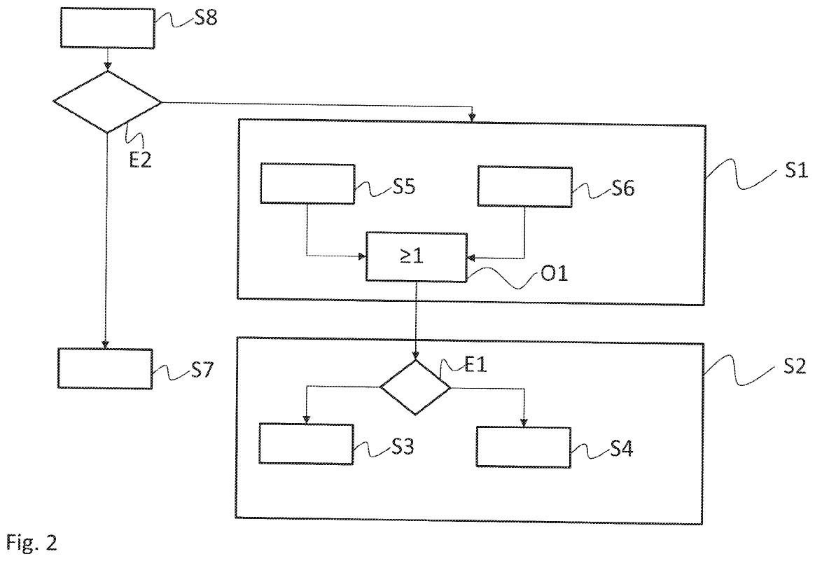

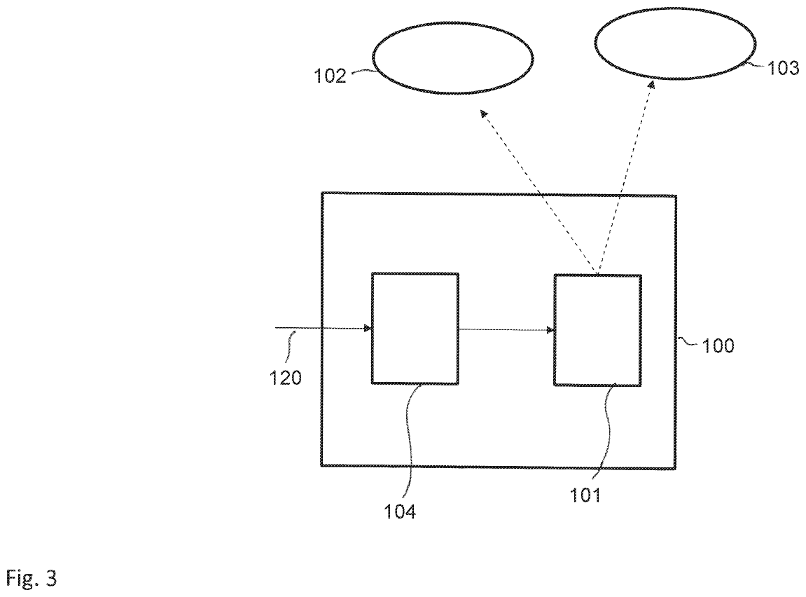

In the description of FIGS. 1 and 2, which relate to the method, the reference signs of FIG. 3-5 are mentioned to provide better understanding.

FIG. 1 is a flow chart of an embodiment of a communication method according to the disclosure herein for satellite-based communication for an aircraft/spacecraft 350.

In the method, the availability of a first satellite-based communication system 102, 202, 302 is monitored S1.

Depending on this monitored availability of the first satellite-based communication system 102, 202, 302, aircraft/spacecraft data 120, 220 are then transmitted via the first satellite-based communication system 102, 202, 302 or a second satellite-based communication system 103, 203, 303.

If the availability of the first satellite-based communication system 102, 202, 302 is limited, the second satellite-based communication system 103, 203, 303 can therefore be used to transmit the data.

The aircraft/spacecraft data 120, 220 can correspond, for example, to the data that a flight data recorder usually stores in an aircraft/spacecraft or can comprise at least a selection of data of this kind. Data of this kind can comprise, for example, flight data, such as the position and orientation of the aircraft/spacecraft, audio data from the cockpit or cabin of the aircraft/spacecraft, image data from the cockpit or cabin of the aircraft/spacecraft, or the like.

The first satellite-based communication system 102, 202, 302 can comprise geostationary satellites 205, 305, for example. When the position of the aircraft/spacecraft 350 changes, an antenna 212 in the aircraft/spacecraft 350 therefore needs to be readjusted such that the relevant satellite 205, 305 is still targeted. Communication via the first satellite-based communication system 102, 202, 302 further has increased energy consumption while simultaneously having a higher data rate. The first satellite-based communication system 102, 202, 302 can be the INMARSAT system, for example.

In comparison with the first satellite-based communication system 102, 202, 302, the second satellite-based communication system 103, 203, 303 comprises non-geostationary satellites 206, 306. The second satellite-based communication system 103, 203, 303 can be the IRIDIUM or IRIDIUM NEXT system, for example.

For communication with non-geostationary satellites, the relevant antennas 213 are designed or configured to cover a plurality of regions simultaneously. In this case, the covered regions are adapted to the distribution of the satellites in the particular system. In addition, an antenna 213 of this kind can also be used, for example, to communicate with an ELT (Emergency Locator Transmitter) system, which is used in an emergency situation to determine or transmit the position and communicates via what is known as the COSPAS-SARSAT satellite system.

FIG. 2 is a flow chart of another embodiment of a communication method according to the disclosure herein.

According to FIG. 2, during monitoring S1, the availability of the first satellite-based communication system 102, 202, 302 can be determined on the basis of a measurement S5 of the quality of the connection to the first satellite-based communication system 102, 202, 302. In addition, the availability of the first satellite-based communication system 102, 202, 302 can be determined S6 on the basis of a current position of the aircraft/spacecraft 350. In this case, not only the current position of the aircraft/spacecraft 350 can be used, but the flight direction and speed of the aircraft/spacecraft can also be taken into account, for example.

If it is ascertained in one of two ways, provided by the OR operation O1, that the availability of the first satellite-based communication system 102, 202, 302 is limited, the decision branches from E1 to S4, where the second satellite-based communication system 103, 203, 303 is used to transmit the aircraft/spacecraft data 120, 220.

In contrast, when the first satellite-based communication system 102, 202, 302 is fully available, the aircraft/spacecraft data 120, 220 can be transmitted S3 via the first satellite-based communication system 102, 202, 302.

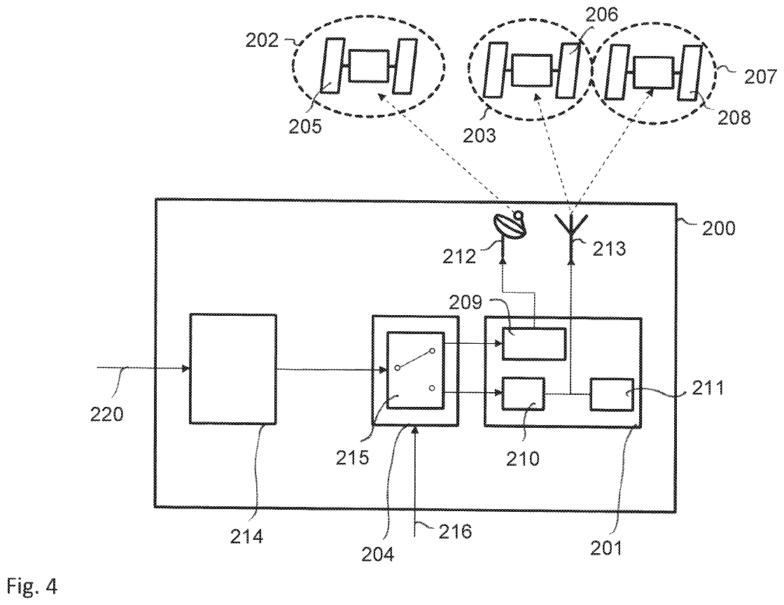

In FIG. 4, the aircraft/spacecraft data 120, 220 is further stored S8. In this case, the aircraft/spacecraft data 120, 220 can be stored in a flight data recorder, for example, which can also output the aircraft/spacecraft data 120, 220 for transmission.

In FIG. 2, the condition of the aircraft/spacecraft is further monitored E2. If it is ascertained in E2 that the aircraft/spacecraft 350 is in an abnormal condition, the aircraft/spacecraft data 120, 220 are transmitted S7 via the second satellite-based communication system 103, 203, 303. This decision is made irrespective of the evaluation in S5 and S6 and is based only on the current condition of the aircraft/spacecraft 350.

FIG. 3 is a block diagram of an embodiment of a communication system 100 according to the disclosure herein for satellite-based communication for an aircraft/spacecraft.

The communication system 100 comprises a communication device 101, which is coupled to a control device 104.

The communication device 101 can communicate with a first satellite-based communication system 102 and with a second satellite-based communication system 103. In addition, the control device 104 can monitor the availability of the first satellite-based communication system 102. The control device 104 then transmits aircraft/spacecraft data 120 via the first satellite-based communication system 102 or the second satellite-based communication system 103 depending on the availability of the first satellite-based communication system 102.

FIG. 4 is a block diagram of another embodiment of a communication system 200 according to the disclosure herein. The communication system 200 is based on the communication system 100 and supplements the system.

According to FIG. 4, the first satellite-based communication system 202 can comprise geostationary satellites 205. Communication using a system of this kind is only possible to a limited extent, i.e. not possible across the entire globe. By contrast, the second satellite-based communication system 203 can comprise non-geostationary satellites 206. In addition, a third satellite-based communication system 207 is provided in FIG. 4. The third satellite-based communication system 207 is an ELT system comprising corresponding satellites 208. The first satellite-based communication system 202 can be the INMARSAT system, for example. The second satellite-based communication system 203 can be the IRIDIUM or IRIDIUM NEXT system, for example.

The communication system 200 comprises two antennas 212, 213 for communication with the above-mentioned satellite-based communication systems 202, 203, 207.

The first antenna 212 is designed or configured to communicate with the first satellite-based communication system 202. Since the first satellite-based communication system 202 comprises geostationary satellites, when the position of the aircraft/spacecraft changes, the first antenna 212 needs to be readjusted such that the relevant satellite 205 is still targeted. Communication via the first satellite-based communication system 202 further has increased energy consumption while simultaneously having a higher data rate.

The second antenna 213 is used to communicate with the second satellite-based communication system 203 and a third satellite-based communication system 207. For communication with non-geostationary satellites 206, 208, the antenna 213 is designed or configured to cover a plurality of regions simultaneously. In this case, the covered regions are adapted to the distribution of the satellites in the particular system. In this case, the second antenna 213 can be designed or configured to be able to reach the satellites 206, 208 of both the second and the third satellite-based communication system 203, 207.

The communication device 201 correspondingly comprises three different satellite modems 209, 210, 211. The first modem 209 is used to communicate via the first satellite-based communication system 202. The second modem 210 is used to communicate via the second satellite-based communication system 203. Finally, the third modem 211 is used to communicate via the third satellite-based communication system 207. In this case, the third modem 212 is not coupled to the control device 204, since the modem does not transmit aircraft/spacecraft data 220.

In addition to the aircraft/spacecraft data 220, the control device 204 also receives an emergency signal 216 from the memory 214. The emergency signal 216 can be generated, for example, by aircraft/spacecraft systems which can identify whether there is an emergency in the aircraft/spacecraft. The control device 204 can output the aircraft/spacecraft data 220 via the first satellite-based communication system 202, for example in normal flight situations, i.e. when there is no emergency. However, if there is an emergency, the change-over switch 215 can switch the control device 204 over to the second satellite-based communication system 203. The energy consumption can thus be reduced since communication with the second satellite-based communication system 203 is less energy-intensive. In addition, it is not necessary to readjust the antenna 212. Communication can thus also be maintained if the position or orientation of the aircraft/spacecraft changes in an uncontrolled manner.

The memory 220 can be a flight data recorder, for example.

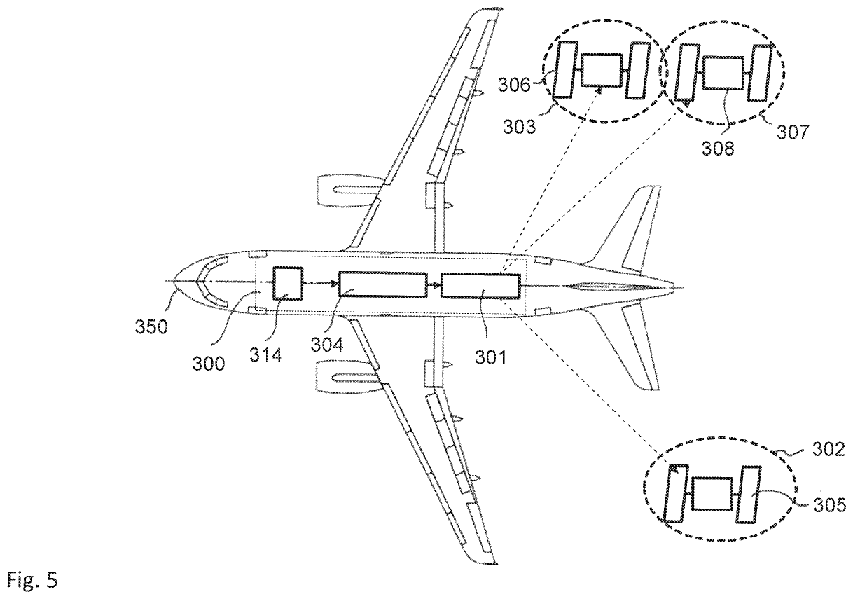

FIG. 5 is a block diagram of an aircraft/spacecraft 350 according to the disclosure herein comprising a communication system 300 according to the disclosure herein. The communication system 300 is shown merely schematically as a memory 314, control device 304 and communication device 301. The communication device 301 can communicate with both the first satellite-based communication system 302 and the second satellite-based communication system 303 and an ELT system 307.

It is clear that each of the embodiments of a communication system according to the disclosure herein described with reference to FIGS. 3 and 4 can be used in the aircraft/spacecraft 350.

In this case, the control device can be integrated in particular in an ELT (Emergency Locater Transmitter) system and the corresponding antenna can be the antenna of the ELT system.

The subject matter disclosed herein can be implemented in software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one exemplary embodiment of the present disclosure herein(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A communication method for satellite-based communication for an aircraft/spacecraft, the method comprising:
monitoring availability of a first satellite-based communication system; and
transmitting aircraft/spacecraft data via the first satellite-based communication system or a second satellite-based communication system depending on the availability of the first satellite-based communication system.

2. The communication method of claim 1, wherein the first satellite-based communication system comprises geostationary satellites.

3. The communication method of claim 1, wherein the second satellite-based communication system comprises non-geostationary satellites.

4. The communication method of claim 1, wherein the aircraft/spacecraft data are transmitted via the first satellite-based communication system when the first satellite-based communication system is fully available and transmitted via the second satellite-based communication system when the availability of the first satellite-based communication system is limited.

5. The communication method of claim 1, wherein the availability of the first satellite-based communication system is determined on a basis of a measurement of a quality of a connection to the first satellite-based communication system.

6. The communication method of claim 1, wherein the availability of the first satellite-based communication system is determined on a basis of a current position of the aircraft/spacecraft.

7. The communication method of claim 1, wherein the aircraft/spacecraft data are transmitted via the second satellite-based communication system when the aircraft/spacecraft is in an abnormal condition.

8. The communication method of claim 7, wherein a selection of the aircraft/spacecraft data is transmitted when the aircraft/spacecraft is in the abnormal condition.

9. The communication method of claim 1, comprising storing the aircraft/spacecraft data during operation of the aircraft/spacecraft and transmitting the aircraft/spacecraft data subject to timeliness of the aircraft/spacecraft data, wherein most up-to-date aircraft/spacecraft data are transmitted first.

10. A communication system for satellite-based communication for an aircraft/spacecraft, comprising:
a communication device, which is configured to communicate with a first satellite-based communication system and with a second satellite-based communication system; and
a control device, which is coupled to the communication device and which is configured to monitor availability of the first satellite-based communication system;
wherein the control device is further configured to transmit aircraft/spacecraft data via the first satellite-based communication system or the second satellite-based communication system depending on the availability of the first satellite-based communication system.

11. The communication system of claim 10, wherein the first satellite-based communication system comprises geostationary satellites.

12. The communication system of claim 10, wherein the second satellite-based communication system comprises non-geostationary satellites

13. The communication system of claim 10, wherein the control device is configured to transmit the aircraft/spacecraft data via the first satellite-based communication system when the first satellite-based communication system is available and via the second satellite-based communication system when the availability of the first satellite-based communication system is limited.

14. The communication system of claim 10, wherein the control device is configured to determine the availability of the first satellite-based communication system on a basis of a measurement of a quality of the connection to the first satellite-based communication system.

15. The communication system of claim 10, wherein the control device is configured to determine the availability of the first satellite-based communication system on a basis of a current position of the aircraft/spacecraft.

16. The communication system of claim 10, wherein the control device is configured to transmit the aircraft/spacecraft data via the second satellite-based communication system when the aircraft/spacecraft is in an abnormal condition.

17. The communication system of claim 16, wherein the control device is configured to transmit a selection of the aircraft/spacecraft data when the aircraft/spacecraft is in the abnormal condition.

18. The communication system of claim 10, comprising a memory which is configured to store the aircraft/spacecraft data during operation of the aircraft/spacecraft, wherein the control device is configured to transmit the stored aircraft/spacecraft data subject to timeliness of the aircraft/spacecraft data, wherein the control device is configured to transmit most up-to-date aircraft/spacecraft data first.

19. An aircraft/spacecraft comprising a communication system, the communication system comprising:
a communication device, which is configured to communicate with a first satellite-based communication system and with a second satellite-based communication system; and
a control device, which is coupled to the communication device and which is configured to monitor availability of the first satellite-based communication system;
wherein the control device is further configured to transmit aircraft/spacecraft data via the first satellite-based communication system or the second satellite-based communication system depending on the availability of the first satellite-based communication system.
